(19) United States
(12) Patent Application Publication
(10) Pub. No.: US 2009/0207769 A1
(43) Pub. Date: Aug. 20, 2009

(54) METHOD AND APPARATUS FOR SCHEDULING TIMING FOR COMMUNICATION BETWEEN SENSOR NODES IN WIRELESS SENSOR NETWORK

(75) Inventors: Sang Joon PARK, Daejeon-city (KR); Young Bag MOON, Daejeon-city (KR); Kangwoo LEE, Daejeon-city (KR); Eylem EKICI, Columbus, OH (US); Emad FELEMBAN, Columbus, OH (US); Serdar VURAL, Columbus, OH (US)

Correspondence Address: CANTOR COLBURN, LLP, 20 Church Street, 22nd Floor, Hartford, CT, 06103, US

(73) Assignees: Electronics and Telecommunications Research Institute, Daejeon-city (KR); The Ohio State University Research Foundation, Columbus, OH (US)

(21) Appl. No.: 12/353,596

(22) Filed: Jan. 14, 2009

Related U.S. Application Data
(60) Provisional application No. 61/020,858, filed on Jan. 14, 2008.

(30) Foreign Application Priority Data
Jul. 15, 2008 (KR) 10-2008-0068663

(51) Int. Cl. H04J 3/00; G08C 17/00

(52) U.S. Cl. 370/311; 370/345

(57) ABSTRACT

Provided is a method of scheduling timing for communication between sensor nodes in a wireless sensor network, the method including categorizing a plurality of sensor nodes in a cluster into several groups, respectively assigning time slots to the groups, and establishing data communication according to the assigned time slots.

### CROSS-REFERENCE TO RELATED PATENT APPLICATION

This application claims the benefit of U.S. Provisional Application No. 61/020,858, filed on Jan. 4, 2008, in the US PTO, and Korean Patent Application No. 10-2008-0068663, filed on Jul. 15, 2008, in the Korean Intellectual Property Office, the disclosures of which are incorporated herein in their entirety by reference.

### BACKGROUND OF THE INVENTION

1. Field of the Invention

The present invention relates to a method and apparatus for scheduling timing for communication between a plurality of sensor nodes in a wireless sensor network (WSN) system, in which the sensor nodes are divided into several groups and time slots are respectively allocated to the groups, thereby preventing collision between the sensor nodes.

2. Description of the Related Art

Use of a directional antenna in wireless networks has been widely discussed in the field to which the present invention pertains. However, most discussions have focused on using the directional antenna in an ad hoc wireless network. Power consumption is a critical issue in this regard. A carrier-sense multiple access (CSMA)-based medium access control (MAC) protocol, such as IEEE 802.11, is not practical for use in a wireless sensor network (WSN) due to high power consumption since nodes need to be active most of the time due to carrier sensing. Furthermore, use of the directional antenna in an ad hoc wireless network causes new communication problems, such as deafness and directional hidden terminals.

Directional hidden terminals refer to a case where if three nodes A, B and C are located in the existing omni-directional environment such that communication can be established between the nodes A and B and between the nodes B and C but cannot be established between the nodes A and C, the node B cannot receive the data from either the node A or the node C due to collisions between the nodes A and C when both the nodes A and C simultaneously transmit data to the node B in order to communicate with the node B. Deafness indicates a case where when a directional antenna of a node A is directed in a first direction, a node B facing the node A in a second direction cannot communicate with the node A before the node A resets the directional antenna in the second direction.

The more nodes there are in a WSN, the more serious the influence of these problems. A time scheduling MAC protocol has been introduced in order to prevent contention between nodes. Use of the time scheduling MAC increases the lifetime of a network and eliminates contention between nodes. However, in the case of a WSN where a large number of nodes are present, calculation of time scheduling is a complex and costly operation. In short, use of the directional antenna in a WSN employing conventional channel access methods leads to problems, such as high power consumption, a high rate of contention, and complex calculation of scheduling.

### SUMMARY OF THE INVENTION

The present invention provides a method and apparatus for scheduling timing for communication between sensor nodes in a WSN, in which the sensor nodes are divided into several groups and data communication is established according to time slots being respectively allocated to the groups.

According to an aspect of the present invention, there is provided a method of scheduling timing for communication between sensor nodes in a wireless sensor network, the method including: categorizing a plurality of sensor nodes in a cluster into several groups; respectively assigning time slots to the groups; and establishing data communication according to the assigned time slots.

According to an aspect of the present invention, there is provided an apparatus for scheduling timing for communication between sensor nodes in a wireless sensor network, the apparatus including: a plurality of sensor nodes in a cluster; and a cluster head node categorizing the sensor nodes into several groups, and respectively assigning time slots to the groups, wherein data communication is established between each of the sensor nodes and the cluster head node according to the assigned time slots.

### BRIEF DESCRIPTION OF THE DRAWINGS

The above and other features and advantages of the present invention will become more apparent by describing in detail exemplary embodiments thereof with reference to the attached drawings in which:

FIG. 1 is a flowchart illustrating a method of scheduling timing for communication between sensor nods in a wireless sensor network (WSN) according to an embodiment of the present invention;

FIG. 2 is a flowchart illustrating an operation of categorizing a plurality of sensor nods in a cluster into several groups, which is included in the method of FIG. 1, according to an embodiment of the present invention;

FIG. 3 is a diagram illustrating a process of designating a group to which a node A belongs according to an embodiment of the present invention;

FIG. 4 illustrates various types of possible conflicts;

FIG. 5 illustrates a method of assigning time slots according to an embodiment of the present invention;

FIG. 6 illustrates the construction of time slots in a sectored antenna-based medium access control (SAMAC) protocol according to an embodiment of the present invention;

FIG. 7 illustrates a sleep mode mechanism according to an embodiment of the present invention;

FIG. 8 illustrates that a node enters a sleep mode after a MIN AWAKE time according to an embodiment of the present invention; and

FIG. 9 is a block diagram illustrating internal SAMAC protocol queues according to an embodiment of the present invention.

### DETAILED DESCRIPTION OF THE INVENTION

Hereinafter, a method of scheduling timing for communication between sensor nodes in a wireless sensor network will be described in greater detail with reference to the accompanying drawings.

In wireless sensor network (WSN) applications under consideration, a WSN architecture is hierarchical and consists of clusters, each having a plurality of sensor nodes and one cluster head. Data collected by sensor nodes within one cluster is forwarded to the cluster head of the cluster via multiple hops. Then, downstream traffic generated toward the cluster head is delivered to an upper-tier gateway node and finally to a single network location, such as a command and control center. Furthermore, messages generated at this central location are to be delivered to sensor nodes in the reverse direction. Since the network is divided into multiple disjointed clusters, each of instances of a protocol runs in each of the clusters. In the present specification, a sectored antenna-based medium access control (SAMAC) protocol will be described with respect to a single cluster.

Reliability of message delivery has first priority over network operations. To this end, a packet loss rate should be minimized. Since a wireless communication medium is shared, packet collisions due to simultaneous packet transmission should also be avoided. Also, there are major issues to be addressed with regard to communication using a directional antenna in a WSN, such as directional hidden terminals and deafness, in addition to limited resources. Hence, SAMAC protocol has the following three objectives: (i) to obtain a high packet delivery ratio by minimizing channel contention and packet collisions in a shared wireless communication medium, (ii) to enhance throughput characteristics of a sensor network by exploiting spatial reuse capabilities of the directional antenna, and (iii) to extend the lifetime of a sensor battery by minimizing power consumption. The SAMAC protocol may be described as a combination of time-division multiple access (TDMA) and channel contention that uses a four-way handshake through packet exchange, i.e., an RTS-CTS-DATA-ACK sequence in IEEE 802.11. This mechanism is based on division of a protocol operation time into disjointed time slots according to TDMA. In each of the time slots, one or more node groups may communicate without influencing other pairs of node groups. Potentially contenting pairs of node groups are scheduled to respectively communicate in different time slots. The SAMAC protocol enables sensor nodes to effectively establish communication in certain time slots. In the other time slots, the sensor nodes operate in an energy-saving sleep mode and turn off an antenna thereof to minimize power consumption. Each of the antennas of the sensor nodes is turned on in a time slot in which the corresponding sensor node is scheduled to communicate. To this end, all the nodes need a time schedule. Calculation of time schedules is performed by a cluster head with plenty of resources and then by sensors within a cluster. For the calculation, the cluster head node needs neighborhood relation information obtained from all sensor nodes in the cluster.

According to an embodiment of the present invention, in a WSN system, sensor nodes may communicate with one another according to a time scheduling method in which sensor nodes are divided into several groups and time slots are respectively allocated to the groups. To this end, each of the sensor nodes includes a multi-sectored antenna via which signals are received from all directions and transmitted to a specific sector, and a transceiver that controls communication. The angular transmission range of the multi-sectored antenna covers the entire omni-directional 360-degree range. Information is transmitted by selecting a sector. An active sector directly receives information without any delay and delivers it to a higher layer in a communication stack. For allocation of time slots, neighborhood relations between the sensor nodes and conflict relations between sectors of neighboring nodes are considered. Also, each of the sensor nodes enters a sleep mode in a time slot to which the sensor node does not belong.

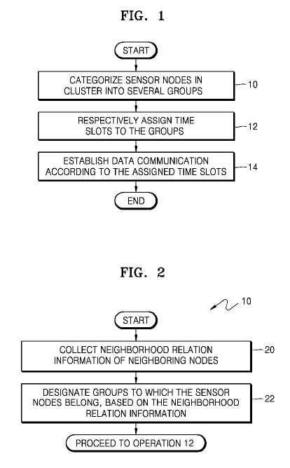

FIG. 1 is a flowchart illustrating a method of scheduling timing for communication between sensor nods in a WSN according to an embodiment of the present invention. First, a plurality of sensor nodes in a cluster are categorized into several groups (operation 10). The sensor nodes do not have preloaded neighborhood relation information, and thus transmit information regarding all neighboring nodes to a cluster head node when an network operation starts.

FIG. 2 is a flowchart illustrating in detail the operation 10 in which the sensor nodes of FIG. 1 are categorized into several groups. First, neighborhood relation information between neighboring nodes of the sensor nodes is collected (operation 20). If each of two nodes can receive a packet of the other node in a single transmission operation over a wireless link, these nodes are neighbors of each other. Thus, the neighborhood relations between two nodes which are each equipped with a multi-sectored antenna includes identification of individual sectors in which these nodes communicate with each other. For example, if a node A transmits and receives packets via a sector 2 thereof and a node B uses a sector 4 thereof in order to communicate with the node A, then node—sector pairs (A, 2) and (B, 4) are neighbors of each other. After the neighborhood relations are discovered by each of the sensor nodes, the relations are forwarded to the cluster head node. The SAMAC protocol collects the neighboring relation information from the cluster head node when the network operation begins.

After operation 20, groups of the sensor nodes are designated using the collected neighboring relation information according to a shortest path tree (operation 22).

The SAMAC protocol creates node groups in order to divide sensor nodes in a cluster into small sets called groups, each of which may be assigned a single time slot. In a SAMAC protocol group, there is at least one parent node and the other sensor nodes are child nodes.

Formation of groups in a cluster is performed by the cluster head node by using the neighborhood relations information. The formation of the groups starts from the cluster head node to child nodes. First, each of sectors of the cluster head node is associated with a different group. Members of these groups are child nodes corresponding to different sectors of the cluster head node. Second, sectors of the child nodes of the cluster head nodes are considered to form new groups. For example, it is assumed that the cluster head node has a child node A. If the child node A has a child node in a shortest path tree, then nodes in a corresponding sector are considered to be categorized as a single group along with the node A. (cluster heads [symbol] cluster head node,

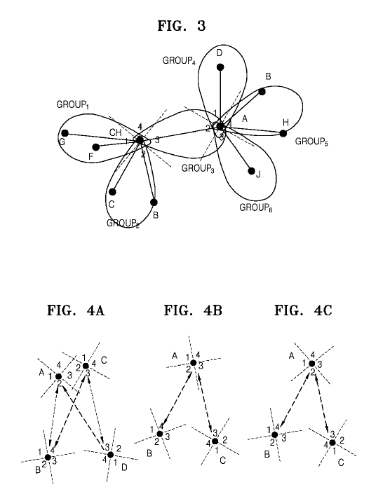

FIG. 3 is a diagram illustrating a process of designating a group to which a node A belongs according to an embodiment of the present invention. Since a sector 2 of the node A has already been included in the group, other sectors may be used in order to form additional groups. This process is continuously performed toward child nodes by iterating this process from parent nodes to child nodes thereof until all nodes are considered.

Referring back to FIG. 1, after operation 10, time slots are respectively assigned to several groups (operation 12). After the groups in the cluster and members of each of the groups are determined, time slots may be respectively assigned to the groups. Before the time slots are assigned, the cluster head node checks the groups for possible common node/interface conflicts by using neighboring relations.

The neighborhood relation information collected by the cluster head node is used to determine potential contending wireless links in the case of synchronous transmission. Such contending wireless links are referred to as conflicts.

FIG. 4 illustrates various types of possible conflicts. Referring to FIG. 4(a), sensor nodes A and B are neighboring nodes, and sensor nodes C and D are neighboring nodes. In order to communicate between the nodes A and B, they need to be scheduled in the same time slot, ranging from a sector 2 to a sector 4. However, data transmitted from the sector 2 of the node A is delivered to a sector 3 of the node D. If the nodes C and D and the nodes A and B are respectively scheduled to communicate in the same time slot, packet conflicts may occur between the nodes C and D and the nodes A and B. Thus, the nodes C and D, and the nodes A and B are preferably scheduled in different time slots. Such conflicts are referred to as common interface conflicts. FIGS. 4(b) and (c) illustrate other examples of common interface conflicts. Referring to FIG. 4(b), there are two pairs of communication nodes, e.g., the nodes A and B and the nodes A and C. The nodes B and C respectively communicate with the node A in different sectors of the node A. Since it is impossible for one node to simultaneously transmit data in more than one sector, the node A cannot communicate with both the nodes B and C at the same time. Accordingly, two pairs of communication nodes should be scheduled in different time slots. Referring to FIG. 4(c), the nodes B and C communicate with the node A in the same sector of the node A. In this case, common node conflicts may be avoided using a contention-based access mechanism.

For allocation for scheduling according to the SAMAC protocol, each of the groups is assigned one or more time slots during which sensor nodes in the group may transmit packets to one another. Assignment of time slots is considered during calculation of scheduling in order to prevent packet conflicts from occurring due to assignment of the same time slots. Collisions between nodes within the same group are handled using contention-based access control as described above. Time slots are respectively assigned to the groups by performing a coloring algorithm, starting from a farthest group to the cluster head. The steps of the coloring algorithm are as follows. First, the hop distance between a parent node of each of the groups and the cluster head node is determined. The hop distance indicates the distance between each of the groups and the cluster head node. Next, the groups are sorted according to the distances between the groups and the cluster head node in descending order. If the distance between one group and the cluster head node is equal to that between another group and the cluster head node, then one of the two groups having more nodes than the other group is considered earlier than the other node. Then, the sorted groups are sequentially scanned until a first group assigned no schedule is discovered. The first group is assigned a color representing a time slots in a multi-hop path of groups defined by a shortest path tree. Each of colors is expressed with an integer. A selected group is assigned a time slots that can first be used from among a set of time slots. If a conflict occurs between groups assigned the same time period, this time period is not available. If a conflict occurs, a color index is increased and it is checked whether a new time slots is to be assigned. When the color index reaches a maximum color index, the maximum color index is assigned to the groups. After a time slots is assigned to a child group, the coloring algorithm is performed on a group-by-group basis. Available color indexes are sequentially assigned in ascending order to each of the groups, starting from a most recently assigned color index. If a time slots is found which causes no conflicts with a previously assigned time slots, then this time period is assigned. If such a time period is not found, the color index exceeds the maximum color index and is thus returned to a first time slots in the set of time slots, and all the time slots are used until the time slots of the child group starts. In this case, the maximum color index is increased, and new colors are assigned to the groups. When colors are assigned to all groups belonging to a branch of groups and a color is to be assigned to the cluster head node, then a next group is selected as a first group from among a list of groups assigned no colors. The new group has a second largest hop distance from the cluster head. The coloring algorithm is completed when color assignment is scheduled for all the groups.

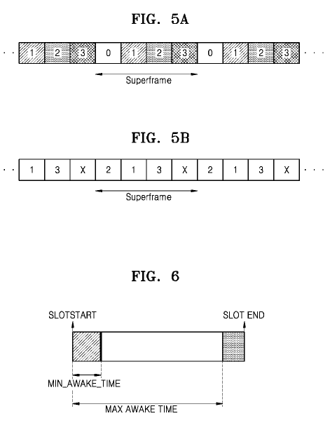

FIG. 5 illustrates a method of assigning time slots according to an embodiment of the present invention. In detail, FIG. 5(a) illustrates a method of assigning time slots, and FIG. 5(b) illustrates sectors being respectively used in active time slots. Here, X denotes that a node is not active in a time slot.

Referring back to FIG. 1, after operation 12, data communication is established according to the assigned time slots (operation 14). At the beginning of the network operation, sensor nodes operate in a basic mode. In the basic mode, a node has no schedule information and there is no discrimination between sectors. In the basic mode, the nodes collect information regarding neighboring nodes thereof and deliver it to the cluster head node. After time schedules are calculated, the cluster head node distributes schedule information to the cluster to which the cluster head node belongs, via a schedule packet. The schedule packet includes information regarding active time slots allocated to all the nodes in the cluster. Upon receipt of the schedule packet, a sensor node extracts the schedule information from the schedule packet, forwards the schedule information to neighboring nodes thereof, initializes the configuration thereof, and enters an advance mode. Eventually, all the nodes in the cluster receive the schedule packet. A sensor node that does not receive the schedule packet cannot participate in the SAMAC protocol and exchange of data in the cluster.

In the advance mode, in each of the time slots, each of the sensor nodes turns off an antenna thereof in order to save power (to enter a sleep mode), or keeps the antenna turned on in order to join communication events. Whether to enter the sleep mode is determined by a time schedule of the sensor node, which is included in the schedule packet. For example, schedule information of a node A is illustrated in Table 1 below.

TABLE 1

| Activation | Time Slot | Active Sector |
|---|---|---|
| True | 0 | 2 |
| True | 1 | 1 |
| True | 2 | 3 |
| False | 3 | X |

In Table 1, a super frame consists of four time slots. In a time slot 3, the node A is not active and thus has no specific sector number in the sleep mode. According to such a schedule of the node A, when a sensor node is active, the node A may communicate with neighboring nodes in only one sector of a given time slot. For example, referring to Table 1, the node A may communicate with neighboring nodes in a sector 3 in a time slot 2. Thus, the node A can transmit packets to a channel and deliver received packets to a protocol stack in the sector 3 in the time slot 2 but cannot transmit packets to the other sectors. Furthermore, packets received from the other sectors are stored in a physical layer and are not delivered to the SAMAC protocol unless the packets need to be processed according to the SAMAC protocol.

FIG. 6 illustrates the construction of time slots in the SAMAC protocol according to an embodiment of the present invention. At the start of each of the time slots, nodes check schedule information thereof in order to determine whether they themselves are active in a time slot. If a node is active in a time slot, the node may join a communication event. The communication event may be data transmission (TX) or data reception (RX). A certain amount of time referred to as a MIN AWAKE time is allocated to determine whether there is communication with another node to be handled.

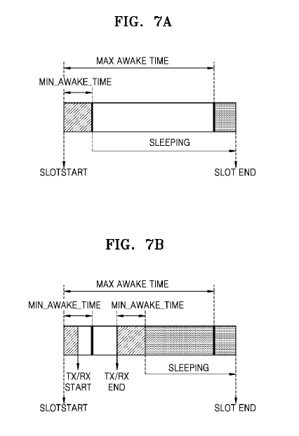

FIG. 7 illustrates a sleep mode mechanism according to an embodiment of the present invention. If a node has no data to transmit and receives no data during the MIN AWAKE time, then the node determines to enter the sleep mode as illustrated in FIG. 7(a). In this case, all antennas are turned off to save power. Thus, there are no interactions with a channel until the node turns on the antennas. If there is a communication event TX/RX, then this event is immediately handled.

At the end of the duration of the communication event TX/RX, each of nodes waits for another MIN AWAKE time in order to determine whether there is new data transmission/reception to be performed. If there is no traffic during the MIN AWAKE time, the node immediately enters the sleep mode as illustrated in FIG. 7(b), otherwise the traffic is immediately handled.

Referring to FIG. 6, the MIN AWAKE time means a maximum time period during which a node can be active in a time slot. The node enters the sleep mode after the MIN AWAKE time passes when a time slot starts, regardless of its state, as illustrated in FIG. 8. The MIN AWAKE time is a configuration parameter and represents a duty cycle in the advance mode.

If the node has a packet to be transmitted in an active time slot, a communication channel should be reserved using 4-way RTS/CTS/DATA/ACK handshaking with a receiver node. This handshaking mechanism is used to eliminate any collision between nodes belonging to the same group. Before transmitting an RTS packet in order to initiate this mechanism, the node needs to backoff from channel access for a certain amount of time.

During the backoff, if the node senses that the channel is busy, then the node pauses the backoff and waits until the channel becomes idle. Once the channel is idle, the node may continue the backoff. When the backoff is completed, the node starts communication using an RTS/CTS/DATA/ACK sequence. If the node needs to sleep for the MIN AWAKE time, a backoff counter is paused and the remaining backoff period is saved to be used in the same time slot in a subsequent super frame.

The SAMAC protocol has backoff values for respective active time slots since communication activities in different sectors of a node may be different from one another. For example, when a node has a remaining backoff time at the end of a time slot 1, then the backoff values will be used in a time slot 1 in a subsequent super frame. Thus, the SAMAC protocol uses conventional backoff procedures in a sequence of RTS/CTS/DATA/ACK frames, and stores current backoff states to be used in the same time slot of the subsequent super frame. Since the time slots are respectively associated with different sectors of the node, the SAMAC protocol effectively differentiates between different traffic in different sectors. The SAMAC protocol handles two traffic directions. Traffic generated toward the cluster head node is referred to as upstream traffic. Traffic coming from the cluster head node is referred to as downstream traffic. The SAMAC protocol treats upstream and downstream traffic in the backoff procedure in different ways. The upstream traffic propagates from a sensor node to the cluster head node and carries urgent data, and thus, a backoff window for transmitting upstream RTS frames is less than a backoff window for transmitting downstream traffic. After each failure to reserve a channel due to an incomplete backoff period, the backoff window is linearly incremented until it reaches an upper limit.

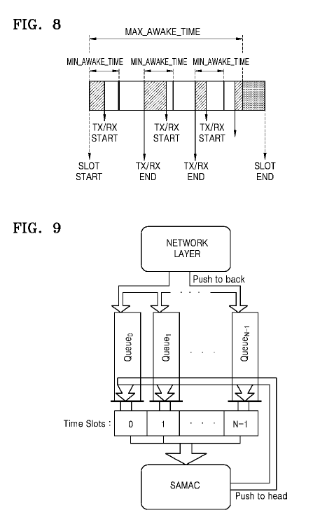

Packets that need to be transmitted using the SAMAC protocol are stored inside internal SAMAC protocol queues. There are separate queues for respective time slots in the SAMAC protocol. Once a packet arrives at a meta access control (MAC) layer, a next hop is determined. If the packet is an upstream packet, the next hop is a parent node of a current node. Thus, the current node finds a time slot in which it may communicate with the parent node thereof and insert the packets in a designated slot queue. The packets are inserted at the tail of the slot queue and popped from the head of the slot queue. If a packet cannot be transmitted in a time slot and a retransmission limit is not exceeded, then the packet is pushed to the top of the slot queue and is treated in a subsequent super frame. FIG. 9 is a block diagram illustrating internal SAMAC protocol queues according to an embodiment of the present invention

A method of scheduling timing for communication between sensor nodes in a wireless sensor network according to the above embodiments of the present invention may be embodied as computer readable code/instructions/program. The present invention also provides a computer readable recording medium having recorded thereon a computer program for executing the method including categorizing a plurality of sensor nodes in a cluster node into several groups; respectively assigning time slots to the groups; and establishing data communication according to the assigned time slots.

The computer program may be stored in a computer readable recording medium and executed using a general digital computer. Examples of the computer readable medium include a magnetic recording medium (a ROM, a floppy disc, a hard disc, etc.), an optical recording medium (a CD-ROM, a DVD, etc.), or even carrier waves (such as in transmission over the Internet). The computer readable medium may be distributed among computer systems that are interconnected through a network, and the present invention may be stored and implemented as computer readable code in the distributed system. Function programs, code, and code segments which constitute the computer program can be easily reasons by a computer programmer in the art.

In a method and apparatus for scheduling timing for communication between sensor nodes in a wireless sensor network according to the above embodiments of the present invention, the sensor nodes are divided into several groups and data communication is established according to time slots being respectively allocated to the groups, thereby preventing collision between the sensor nodes, minimizing power consumption in the sensor nodes, and increasing the lifetime of the sensor nodes.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of scheduling timing for communication between sensor nodes in a wireless sensor network, the method comprising:
categorizing a plurality of sensor nodes in a cluster into several groups;
respectively assigning time slots to the groups; and
establishing data communication according to the assigned time slots.

2. The method of claim 1, wherein the categorizing of the sensor nodes comprises:
collecting neighborhood relation information of neighboring nodes of the sensor nodes; and
designating the groups to which the sensor nodes belong according to a shortest path tree, based on the neighborhood relation information.

3. The method of claim 1, wherein the respectively assigning of the time slots to the groups comprises respectively assigning time slots to the groups, in consideration of neighborhood relation information of neighboring nodes of the sensor nodes and conflict relations between the neighboring nodes according to the neighborhood relation information.

4. The method of claim 1, wherein the establishing of data communication according to the assigned time slots comprises each of the sensor nodes entering a sleep mode in time slots to which each sensor node belongs.

5. An apparatus for scheduling timing for communication between sensor nodes in a wireless sensor network, the apparatus comprising:
a plurality of sensor nodes in a cluster; and
a cluster head node categorizing the sensor nodes into several groups, and respectively assigning time slots to the groups,
wherein data communication is established between each of the sensor nodes and the cluster head node according to the assigned time slots.

6. The apparatus of claim 5, wherein each of the sensor nodes comprises:
a multi-sectored antenna via which signals are received from all directions and transmitted to a specific sector: and
a transceiver controlling communication.

7. The apparatus of claim 5, wherein the cluster head node collects neighborhood relation information of neighboring nodes of the sensor nodes, and designates the groups to which the sensor nodes belong, based on neighborhood relation information.

8. The apparatus of claim 5, wherein the cluster head node respectively assigns time slots to the groups, in consideration of neighborhood relation information of neighboring nodes of the sensor nodes and conflict relations between the neighboring nodes according to the neighborhood relation information.

9. The apparatus of claim 5, wherein each of the sensor nodes enters a sleep mode in time slots to which the sensor node belongs.
